(19) United States
(12) Patent Application Publication
(10) Pub. No.: US 2025/0313917 A1
(43) Pub. Date: Oct. 9, 2025

(54) POSITIVE ELECTRODE ACTIVE MATERIAL USING SPENT BATTERY LEACHATE FOR SECONDARY BATTERY AND METHOD OF PREPARING SAME

(71) Applicant: HANWHA CORPORATION, Seoul (KR)

(72) Inventors: Kyungjung Kwon, Seoul (KR); Seoa Kim, Seoul (KR); Namho Koo, Seoul (KR); Chanmin Kim, Seoul (KR); Sanghyuk Park, Seoul (KR)

(73) Assignee: HANWHA CORPORATION, Seoul (KR)

(21) Appl. No.: 18/650,585

(22) Filed: Apr. 30, 2024

(30) Foreign Application Priority Data
Apr. 4, 2024 (KR) 10-2024-0045870

(51) Int. Cl. C22B 7/00; C01G 51/00; C22B 3/38; C22B 3/40; H01M 10/54

(52) U.S. Cl. CPC C22B 7/007; C01G 51/42; C22B 3/383; C22B 3/402; H01M 10/54; C01P 2004/61; C01P 2006/40

(57) ABSTRACT

Proposed are a positive electrode active material using a spent battery leachate for secondary batteries and a method of preparing the same. Using a spent battery leachate enables the positive electrode active material for secondary batteries, the positive electrode active material having a composition of Li(NiₐCo_{b}Al_{c})O₂ (where a+b+c=1) including Ni, Co, and Al and being prepared from a precursor having a composition of NiₐCo_{b} (where a+b=1), to be prepared. As a result, some raw materials can be replaced with the spent battery leachate when preparing the positive electrode active material for secondary batteries, thereby reducing manufacturing costs and solving environmental problems.

### CROSS REFERENCE TO RELATED APPLICATION

The present application claims priority to Korean Patent Application No. 10-2024-0045870, filed Apr. 4, 2024, the entire contents of which is incorporated herein for all purposes by this reference.

### TECHNICAL FIELD

The present disclosure relates to a positive electrode active material using a spent battery leachate for a secondary battery and a method of preparing the same. Specifically, the present disclosure relates to a positive electrode active material using a spent battery leachate for a secondary battery and a method of preparing the same, the positive electrode active material being prepared by recycling spent batteries to reduce manufacturing costs and solve environmental problems.

### BACKGROUND ART

Recently, with the increasing demand for eco-friendly energy due to global warming, there has been a rapidly growing demand for secondary batteries in electric vehicles and the like.

In particular, as the market for electric vehicles grows, the use of battery packs having high capacitance with a plurality of unit battery cells is increasing.

Accordingly, rapid increases in spent battery packs resulting from electric vehicles are expected, and the need for spent battery recycling grows to effectively utilize limited resources.

In the related art, Korean Patent No. 10-1440241, “NCA-BASED POSITIVE ELECTRODE ACTIVE MATERIAL FOR LITHIUM SECONDARY BATTERY, METHOD OF PREPARING SAME, AND LITHIUM SECONDARY BATTERY INCLUDING SAME”, has been proposed.

However, in Korean Patent No. 10-1440241, “NCA-BASED POSITIVE ELECTRODE ACTIVE MATERIAL FOR LITHIUM SECONDARY BATTERY, METHOD OF PREPARING SAME, AND LITHIUM SECONDARY BATTERY INCLUDING SAME”, a Ni-rich positive electrode active material, which has high capacity characteristics by co-precipitation of hydroxide salt, is prepared by synthesizing a precursor through co-precipitation of nickel and cobalt. As a result, there are environmentally unfriendly problems of requiring increased manufacturing costs and not using spent batteries.

### DISCLOSURE

### Technical Problem

The present disclosure aims to provide a positive electrode active material using a spent battery leachate for a secondary battery and a method of preparing the same, the positive electrode active material being prepared by recycling spent batteries to reduce manufacturing costs and solve environmental problems.

### Technical Solution

To achieve the objectives as described above, one embodiment of a positive electrode active material using a spent battery leachate for a secondary battery, according to the present disclosure, is characterized by having a composition of Li(NiₐCo_{b}Al_{c})O₂ (where a+b+c=1) including Ni, Co, and Al and being prepared from a precursor having a composition of NiₐCo_{b} (where a+b=1).

In the present disclosure, the positive electrode active material is characterized in that the precursor has a composition including (Na, Al, Fe, Cu, Zn, Mg, Ca, Mn)ₓ (where 0.0001≤x<0.05, and a+b+x=1) in addition to the NiₐCo_{b} composition (where a+b=1).

In the embodiment, the positive electrode active material, according to the present disclosure, may have a composition including (Na, Al, Fe, Cu, Zn, Mg, Ca, Mn)ₓ (where 0.0001≤x<0.05, and a+b+c+x=1) in addition to the ternary Li(NiₐCo_{b}Al_{c})O₂ composition (where a+b+c=1).

In the embodiment, the positive electrode active material, according to the present disclosure, may have an average particle diameter in a range of 4 to 15 μm.

Additionally, in one embodiment, a method of preparing a positive electrode active material using a spent battery leachate for a secondary battery, according to the present disclosure, is characterized by including the following steps: preparing a spent battery leachate; preparing a transition metal solution containing a predetermined amount or more of Ni by increasing a volume of the resulting leachate; and reacting a mixture of the transition metal solution, an ammonia chelating agent, and a basic aqueous solution in a reactor to prepare a precursor of a positive electrode active material.

In the present disclosure, in the step of reacting the mixture, the precursor having a composition of NiₐCo_{b} (where a+b=1) may be prepared.

In the present disclosure, the precursor may have a composition including (Na, Al, Fe, Cu, Zn, Mg, Ca, Mn)ₓ (where 0.0001≤x<0.05, and a+b+x=1) in addition to the NiₐCo_{b} composition (where a+b=1).

In the present disclosure, the step of preparing the leachate may include: a leachate preparation process to prepare a leachate by subjecting valuable metal powders obtained from a spent battery to acid treatment in a reducing atmosphere; and an impurity removal process to remove impurities from the leachate.

In the present disclosure, the impurity removal process may include: a precipitation process to remove impurities including Al, Fe, and Cu present in the leachate by adding a basic solution; and a solvent extraction process to remove impurities including Mn, Ca, Zn, and Mg from the resulting leachate, from which some of the impurities are removed through the precipitation process, by using an acid organic solvent.

In the present disclosure, in the solvent extraction process, a mixed solvent of di(2-ethylhexyl)phosphoric acid and kerosene may be used.

In the present disclosure, the impurity removal process may further include a leachate recovery process to recover NiSO₄, CoSO₄, and MnSO₄ from the resulting extraction solution obtained through the solvent extraction process by using the acid organic solvent, the extraction solution including Ni, Co, and Mn extracts containing Ni, Co, and Mn, respectively.

In the present disclosure, in the step of preparing the transition metal solution, the transition metal solution may be prepared by mixing 28 to 35 wt % of the leachate and 65 to 72 wt % of a metal solution for a volume increase to increase proportions of Ni and Co in 100 wt % of the transition metal solution.

In the present disclosure, in the step of reacting the mixture, the precursor capable of preparing the positive electrode active material may be prepared by mixing the transition metal solution, the ammonia chelating agent, and the basic aqueous solution as a reaction solution in the reactor and then reacting the resulting reaction solution for 10 to 30 hours in a nitrogen atmosphere.

In the present disclosure, in the step of reacting the mixture, a molar ratio of ammonia to a metal salt is in a range of 0.5 to 1.0, the reaction solution has a pH in a range of 10.0 to 12.0 and a temperature in a range of 40° C. to 60° C., and the reaction solution is stirred with a stirrer at a speed in a range of 700 to 1500 rpm.

In the embodiment, the method of preparing the positive electrode active material, according to the present disclosure, may further include a step of sintering a mixture of the resulting precursor being washed to remove impurities, a lithium salt, and an aluminum salt through heat treatment to prepare the positive electrode active material.

In the present disclosure, the step of sintering the mixture may include: a primary sintering process to keep the resulting mixture obtained by mixing the precursor, the lithium salt, and the aluminum salt at a temperature in a range of 300° C. to 500° C. for 3 to 10 hours; and a secondary sintering process to sinter the resulting product obtained through the primary sintering process at a temperature in a range of 700° C. to 850° C. for 13 to 20 hours.

### Advantageous Effects

The present disclosure can reduce manufacturing costs and solve environmental problems by replacing some raw materials with a spent battery leachate when preparing a positive electrode active material for a secondary battery.

Additionally, the present disclosure can simplify the preparation process by removing impurities from the spent battery leachate through precipitation and significantly reduce the costs required for spent battery recycling, thereby significantly improving the economic feasibility of spent battery recycling.

### DESCRIPTION OF DRAWINGS

FIG. 1 is a flowchart illustrating one embodiment of a method of preparing a positive electrode active material using a spent battery leachate for a secondary battery according to the present disclosure;

FIG. 2 illustrates diagrams for Example 1 and Comparative Examples 1 to 5 of positive electrode active materials using spent battery leachates for secondary batteries according to the present disclosure;

FIG. 3 shows a graph of voltage ratio relative to capacitance in secondary batteries manufactured by Example 1 and Comparative Examples 1 to 5 of the present disclosure;

FIG. 4 illustrates a graph of capacitance relative to battery cycles in secondary batteries manufactured by Example 1 and Comparative Examples 1 to 5 of the present disclosure; and

FIG. 5 illustrates a graph of capacity retention rate (%) relative to battery cycles in secondary batteries manufactured by Example 1 and Comparative Examples 1 to 5 of the present disclosure.

### MODE FOR INVENTION

Hereinafter, preferred embodiments of the present disclosure will be described in more detail with reference to the accompanying drawings. However, the technical spirit of the present disclosure is not limited to the embodiments described herein, and the embodiments of the present disclosure may be modified in various forms. The embodiments described herein are provided so that the disclosure can be made thorough and complete and that the spirit of the present disclosure can be fully conveyed to those skilled in the art.

As used herein, when a component is referred to as being on another, one component may be formed directly on another, or other components may be interposed between the components. Additionally, it should be understood that the shape and thickness of areas shown in the drawings may be exaggeratedly drawn to describe the content of the present disclosure effectively.

Additionally, it will be understood that, although the terms first, second, third, and the like may be used to describe various components, these components are not limited by these terms. These terms are only used to distinguish one component from another. Thus, a first element, component, region, layer, or section in one embodiment may be referred to as a second element, component, region, layer, or section in another embodiment. Each embodiment described and illustrated herein also includes complementary embodiments thereof. Additionally, as used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “include”, and/or “have” used herein specify the presence of stated features, integers, steps, operations, elements, or components, but do not preclude the presence or addition of one or more other features, integers, steps, operations, elements, components, or groups thereof. Additionally, as used herein, when one element or component is referred to as being “connected” or “coupled”, a plurality of elements or components can be indirectly or directly coupled or connected.

Additionally, in describing the present disclosure, if it is determined that a detailed description of a related known function or configuration may unnecessarily obscure the gist of the present disclosure, the detailed description will be omitted.

In one embodiment, one example of a positive electrode active material using a spent battery leachate for secondary batteries, according to the present disclosure, has a composition of Li(NiₐCo_{b}Al_{c})O₂ (where a+b+c=1) including Ni, Co, and Al and is prepared from a precursor having a composition of NiₐCo_{b} (where a+b=1).

The precursor having the composition of NiₐCo_{b} (where a+b=1) is obtainable from spent batteries, and one example thereof is a precursor contained in a spent battery leachate prepared by subjecting valuable metal powders containing Li, Ni, Co, and Mn to acid treatment.

Additionally, in the embodiment, one example of the positive electrode active material using the spent battery leachate for secondary batteries, according to the present disclosure, has a composition of Li(NiₐCo_{b}Al_{c})O₂ (where a+b+c=1) including all Ni, Co, and Al through a leachate-mixed metal solution in which the spent battery leachate containing the precursor having the composition of NiₐCo_{b} (where a+b=1) and a metal solution containing a predetermined amount or more of Ni are mixed.

Additionally, the precursor may further include at least one among Na, Al, Fe, Cu, Zn, Mg, Ca, and Mn in addition to the NiₐCo_{b} (where a+b=1) composition.

In other words, the precursor may include (Na, Al, Fe, Cu, Zn, Mg, Ca, Mn)ₓ (where 0.0001≤x<0.05, and a+b+x=1) in addition to the NiₐCo_{b} (where a+b=1) composition.

More specifically, the precursor may have a composition of NiₐCo_{b}(Na, Al, Fe, Cu, Zn, Mg, Ca, Mn)ₓ (where 0.0001≤x<0.05, and a+b+x=1) including all Na, Al, Fe, Cu, Zn, Mg, Ca, and Mn.

Additionally, in the embodiment, the positive electrode active material using the spent battery leachate for secondary batteries, according to the present disclosure, which is prepared using the precursor having the composition of NiₐCo_{b}(Na, Al, Fe, Cu, Zn, Mg, Ca, Mn)ₓ (where 0.0001≤x<0.05, and a+b+x=1) contained in the spent battery leachate, may have a composition including (Na, Al, Fe, Cu, Zn, Mg, Ca, Mn)ₓ (where 0.0001≤x<0.05, and a+b+c+x=1) in addition to the ternary Li(NiₐCo_{b}Al_{c})O₂ composition (where a+b+c=1).

In other words, in the embodiment, the positive electrode active material using the spent battery leachate for secondary batteries, according to the present disclosure, may include at least one among Na, Al, Fe, Cu, Zn, Mg, Ca, and Mn. Alternatively, the positive electrode active material may include all Na, Al, Fe, Cu, Zn, Mg, Ca, and Mn and thus have a composition of Li(NiₐCo_{b}Al_{c})O₂(Na, Al, Fe, Cu, Zn, Mg, Ca, Mn)ₓ (where 0.0001≤x<0.05, and a+b+c+x=1).

In the embodiment, one example of the positive electrode active material using the spent battery leachate for secondary batteries, according to the present disclosure, further includes Mg and Mn and thus has a composition of Li(NiₐCo_{b}Al_{c})O₂(Mg, Mn)ₓ (where 0.0001≤x<0.05, and a+b+c+x=1).

Additionally, one example of the positive electrode active material using the spent battery leachate for secondary batteries, according to the present disclosure, includes 84.68 to 84.85 mol % of Ni, 10.15 to 10.25 mol % of Co, 4.9 to 5.1 mol % of Al, 0.05 to 0.07 mol % of Mg, and 0.03 to 0.04 mol % of Mn, in 100 mol % of the total amount thereof.

In the embodiment, the positive electrode active material using the spent battery leachate for secondary batteries, according to the present disclosure, includes Ni, Co, Al, Mg, and Mn in the molar ratio described above, enabling high capacitance, not significantly differing from that of positive electrode active materials for secondary batteries freshly prepared without using spent battery leachates, to be exhibited and the high capacitance to be maintained with long-term stability.

Additionally, in the embodiment, one example of the positive electrode active material using the spent battery leachate for secondary batteries, according to the present disclosure, has an average particle diameter in a range of 4 to 15 μm, enabling high capacitance, not significantly differing from that of positive electrode active materials for secondary batteries freshly prepared to have an average particle diameter in a range of 4 to 15 μm, to be exhibited and the high capacitance to be maintained with long-term stability.

In the case where the average particle diameter is smaller than 4 μm, or the average particle diameter exceeds 15 μm, there may be problems that high capacitance is challenging to exhibit compared to the case of positive electrode active materials for secondary batteries freshly prepared without using spent battery leachates, and long-term stability of the high capacitance is challenging to maintain.

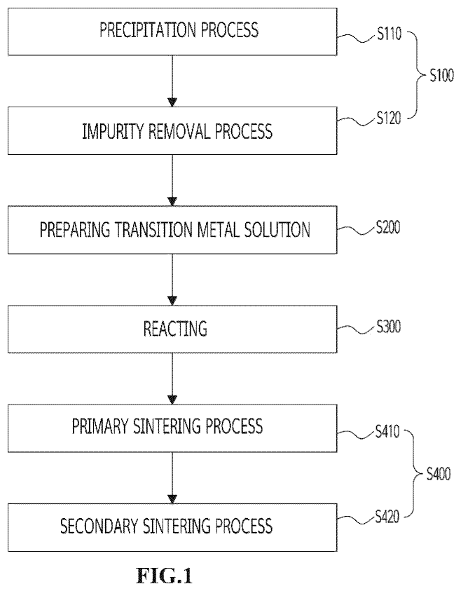

On the other hand, FIG. 1 is a flowchart illustrating one embodiment of a method of preparing a positive electrode active material using a spent battery leachate for secondary batteries according to the present disclosure. Referring to FIG. 1, in the embodiment, the method of preparing the positive electrode active material using the spent battery leachate for secondary batteries, according to the present disclosure, is characterized by including the following steps: S100 of preparing a spent battery leachate; S200 of preparing a transition metal solution containing a predetermined amount or more of Ni by increasing a volume of the resulting leachate; and S300 of reacting a mixture of the transition metal solution, an ammonia chelating agent, and a basic aqueous solution in a reactor.

In step S100 of preparing the leachate, the leachate is prepared by subjecting valuable metal powders obtained from a spent battery to acid treatment in a reducing atmosphere.

The valuable metal powders obtained from the spent battery include Li, Ni, Co, Al, Mg, and Mn and may, furthermore, include Na, Fe, Cu, Zn, and Ca.

It should be noted that the process of obtaining the valuable metal powders, including Li, Ni, Co, Al, Mg, and Mn, from the spent battery may be variously modified and performed through known metal recovery processes, so further detailed descriptions are omitted.

One example of the leachate contains a precursor having a composition of NiₐCo_{b} (where a+b=1).

Additionally, the precursor contained in the leachate may have a composition including (Na, Al, Fe, Cu, Zn, Mg, Ca, Mn)ₓ (where 0.0001≤x<0.05, and a+b+x=1) in addition to the NiₐCo_{b} composition (where a+b=1).

In the embodiment, one example of the method of preparing the positive electrode active material using the spent battery leachate for secondary batteries, according to the present disclosure, involves preparing a positive electrode active material for secondary batteries, the positive electrode active material having a composition of Li(NiₐCo_{b}Al_{c})O₂ (where a+b+c=1) including Ni, Co, and Al and being prepared from the precursor contained in the leachate.

The precursor having the composition of NiₐCo_{b} (where a+b=1) is obtainable from spent batteries, and one example thereof is a precursor contained in a spent battery leachate prepared by subjecting valuable metal powders containing Li, Ni, Co, and Mn to acid treatment.

In other words, in the embodiment, one example of the positive electrode active material using the spent battery leachate for secondary batteries, according to the present disclosure, has a composition of Li(NiₐCo_{b}Al_{c})O₂ (where a+b+c=1) including all Ni, Co, and Al through a leachate-mixed metal solution in which the spent battery leachate containing the precursor having the composition of NiₐCo_{b} (where a+b=1) and a metal solution containing a predetermined amount or more of Ni are mixed.

More specifically, the precursor in the leachate may have a composition of NiₐCo_{b}(Na, Al, Fe, Cu, Zn, Mg, Ca, Mn)ₓ (where 0.0001≤x<0.05, and a+b+x=1) including all Na, Al, Fe, Cu, Zn, Mg, Ca, and Mn.

Step S100 of preparing the leachate includes: a leachate preparation process to prepare a leachate by subjecting valuable metal powders obtained from a spent battery to acid treatment in a reducing atmosphere; and impurity removal process S120 to remove impurities from the leachate.

The leachate preparation process involves preparing the leachate by subjecting the valuable metal powders obtained from the spent battery to acid treatment using an acid solution such as sulfuric acid (H₂SO₄) and hydrochloric acid (HCl).

Additionally, impurity removal process S120 includes: precipitation process S110 to remove impurities including Al, Fe, and Cu present in the leachate by adding a basic solution; and a solvent extraction process to remove impurities including Mn, Ca, Zn, and Mg from the resulting leachate, from which some of the impurities are removed through precipitation process S110, by using an acid organic solvent.

In impurity removal process S120, the impurities of Al, Fe, Cu, Mn, Ca, Zn, and Mg are removed from the leachate primarily prepared using the valuable metal powders obtained from the spent battery, thereby improving the purity of major metals, Ni, Co, and Mn.

In one example of the solvent extraction process, a mixed solvent of di(2-ethylhexyl)phosphoric acid and kerosene is used. Using such a mixed acid organic solvent of di(2-ethylhexyl)phosphoric acid and kerosene, Mn is first extracted and removed, followed by precipitating and removing all Ca, Zn, and Mg.

All Ca, Zn, and Mg have similar extraction behavior to Mn and thus may be extracted and removed along with Mn using the acidic organic solvent.

Impurity removal process S120 further includes a leachate recovery process to recover NiSO₄, CoSO₄, and MnSO₄ from the resulting extraction solution obtained through the solvent extraction process by using the acid organic solvent, the extraction solution including Ni, Co, and Mn extracts containing Ni, Co, and Mn, respectively.

The leachate recovery process involves recovering NiSO₄, CoSO₄, and MnSO₄ solutions by each independently subjecting Co, Ni, and Mn extraction solutions having been separated and extracted from the resulting leachate, from which the impurities of Al, Fe, Cu, Mn, Ca, Zn, and Mg are removed through the solvent extraction process by using the acid organic solvent such as phosphinic acid-based, phosphoric acid-based, and phosphonic acid-based solvents, to removal processes.

Additionally, in step S200 of preparing the transition metal solution, the final transition metal solution in which the proportions of Ni and Co are adjusted to a pre-designed composition is prepared by mixing a metal solution for a volume increase in the recovered leachate recovery solution, that is, a mixed leachate recovery solution of the NiSO₄, CoSO₄, and MnSO₄ solutions.

One example of the leachate recovery solution includes 33700 to 34000 ppm/mg·L⁻¹ of Ni, 158000 to 159000 ppm/mg·L⁻¹ of Co, 7400 to 7500 ppm/mg·L⁻¹ of Li, 44 to 48 ppm/mg·L⁻¹ of Mn, 52000 to 53000 ppm/mg·L⁻¹ of Na, 1.0 to 2.0 ppm/mg·L⁻¹ of Cu, 8 to 10 ppm/mg·L⁻¹ of Ca, and 60 to 63 ppm/mg·L⁻¹ of Mg.

The metal solution for the volume increase has a composition in which the proportions of Ni and Co are increased to match those in the case of using spent battery leachates in transition metal solutions used to prepare existing positive electrode active materials for secondary batteries. In this case, it should be noted that only the proportions of Ni and Co are increased in transition metal solutions used to prepare existing positive electrode active materials for secondary batteries, so further detailed descriptions are omitted.

Additionally, in one example of step S200 of preparing the transition metal solution, the transition metal solution is prepared by mixing 28 to 60 wt % of the leachate recovery solution and to 72 wt % of the metal solution for the volume increase in 100 wt % of the transition metal solution.

When the transition metal solution contains less than 28 wt % of the leachate recovery solution, economic feasibility may be challenging to achieve. On the contrary, when the transition metal solution contains more than 60 wt % of the leachate recovery solution, there may be problems that impurities contained in the leachate recovery solution cause difficulties in exhibiting the target high capacitance, and long-term stability of the capacitance is challenging to maintain.

More preferably, in step S200 of preparing the transition metal solution, the transition metal solution is prepared by mixing 28 to 35 wt % of the leachate recovery solution and 65 to 72 wt % of the metal solution for the volume increase in 100 wt % of the transition metal solution.

Additionally, performance not inferior to that of positive electrode active materials for secondary batteries freshly prepared without using spent battery leachates may be exhibited by including 35 wt % or less of the leachate recovery solution in 100 wt % of the transition metal solution. In other words, high capacitance may be well exhibited compared to that of positive electrode active materials for secondary batteries freshly prepared without using spent battery leachates, and the high capacitance may be maintained with long-term stability.

In step S300 of reacting the mixture, the precursor capable of preparing the positive electrode active material is prepared by mixing the transition metal solution, the ammonia chelating agent, and the basic aqueous solution in the reactor as a reaction solution and then reacting the resulting reaction solution for 10 to 30 hours in a nitrogen atmosphere.

Additionally, in one example of step S300 of reacting the mixture, the molar ratio of ammonia to a metal salt is in a range of 0.5 to 1.0, the reaction solution has a pH in a range of 10.0 to 12.0 and a temperature in a range of 40° C. to 60° C., and the reaction solution is stirred with a stirrer at a speed in a range of 700 to 1500 rpm during the reaction in the reactor.

Additionally, in the embodiment, the method of preparing the positive electrode active material using the spent battery leachate for secondary batteries, according to the present disclosure, further includes step S400 of sintering a mixture of the resulting precursor being washed to remove impurities, a lithium salt, and an aluminum salt through heat treatment to prepare the positive electrode active material for secondary batteries.

Step S400 of sintering the mixture includes: primary sintering process S410 to keep the resulting mixture obtained by mixing the precursor, the lithium salt, and the aluminum salt at a temperature in a range of 300° C. to 500° C. for 3 to 10 hours; and secondary sintering process S420 to sinter the resulting product obtained through primary sintering process S410 at a temperature in a range of 700° C. to 850° C. for 13 to 20 hours.

Step S400 of sintering the mixture may enable the capacitance to be maintained with long-term stability by making the structure of the positive electrode active material for secondary batteries more solid and dense through primary sintering process S410 and secondary sintering process S420.

The positive electrode active material for secondary batteries, prepared through step S400 of sintering the mixture, is a positive electrode active material for lithium secondary batteries, and one example thereof has a molar composition including 84.68 to 84.85 mol % of Ni, 10.15 to 10.25 mol % of Co, 4.9 to 5.1 mol % of Al, 0.05 to 0.07 mol % of Mg, and 0.03 to 0.04 mol % of Mn, in 100 mol % of the total amount thereof.

In other words, in the embodiment of the method of preparing the positive electrode active material using the spent battery leachate for secondary batteries according to the present disclosure, the positive electrode active material for secondary batteries, including Ni, Co, Al, Mg, and Mn in the molar ratio described above, may be prepared, enabling high capacitance, not significantly differing from that of positive electrode active materials for secondary batteries freshly prepared by existing methods, to be exhibited and the high capacitance to be maintained with long-term stability.

Additionally, in step S400 of sintering the mixture, the positive electrode active material for secondary batteries is prepared to have an average particle diameter in a range of 4 to 15 μm, enabling high capacitance, not significantly differing from that of positive electrode active materials for secondary batteries freshly prepared, to be exhibited and the high capacitance to be maintained with long-term stability.

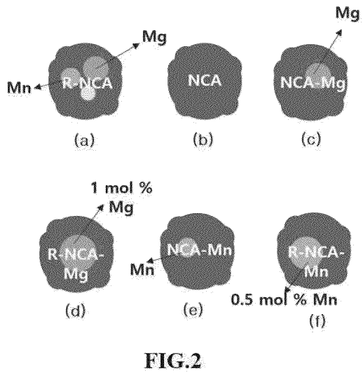

FIG. 2 illustrates diagrams for Example 1 and Comparative Examples 1 to 5 of positive electrode active materials using spent battery leachates for secondary batteries according to the present disclosure. More specifically, FIG. 2A is a schematic diagram illustrating positive electrode active material particles for secondary batteries in Example 1 of the present disclosure, FIG. 2B is a schematic diagram illustrating positive electrode active material particles for secondary batteries in Comparative Example 1 of the present disclosure, FIG. 2C is a schematic diagram illustrating positive electrode active material particles for secondary batteries in Comparative Example 2 of the present disclosure, FIG. 2D is a schematic diagram illustrating positive electrode active material particles for secondary batteries in Comparative Example 3 of the present disclosure, FIG. 2E is a schematic diagram illustrating positive electrode active material particles for secondary batteries in Comparative Example 4 of the present disclosure, and FIG. 2F is a schematic diagram illustrating positive electrode active material particles for secondary batteries in Comparative Example 5 of the present disclosure.

In Comparative Example 1, an NCA-based positive electrode active material having a composition including Ni, Co, and Al as in Example 1 was prepared by an existing method of preparing positive electrode active materials, without using the spent battery leachate.

In Comparative Example 2, an NCA-based positive electrode active material was synthesized by simulating the amount of Mg contained in the spent battery leachate used in Example 1 of the present disclosure.

In Comparative Example 3, an NCA-based positive electrode active material was synthesized by adding about 1 mol % of Mg to the spent battery leachate used in Example 1 of the present disclosure.

In Comparative Example 4, an NCA-based positive electrode active material was synthesized by simulating the amount of Mn contained in the spent battery leachate used in Example 1 of the present disclosure.

In Comparative Example 5, an NCA-based positive electrode active material was synthesized by adding 0.489 mol % of Mg to the spent battery leachate used in Example 1 of the present disclosure, wherein the amount of Mn contained in the leachate was 10 or more times larger than that in the case of Example 1.

The amount (mol %) of each element used in Example 1 and Comparative Examples 1 to 5 of the present disclosure are shown in Table 1 below.

TABLE 1

| | Amount of element (mol %) | | | | | |
|---|---|---|---|---|---|---|
| | | Comparative | Comparative | Comparative | Comparative | Comparative |
| Element | Example 1 | Example 1 | Example 2 | Example 3 | Example 4 | Example 5 |
| Ni | 84.76 | 85.20 | 84.92 | 84.49 | 84.99 | 85.03 |
| Co | 10.18 | 9.80 | 10.09 | 1012 | 10.06 | 9.85 |
| Al | 4.96 | 5.01 | 4.93 | 5.11 | 4.92 | 5.11 |
| Mg | 0.065 | 0 | 0.065 | 1.023 | 0 | 0.074 |
| Mn | 0.035 | 0 | 0 | 0.034 | 0.032 | 0.489 |
| Cu | N.D | N.D | N.D | N.D | N.D | N.D |

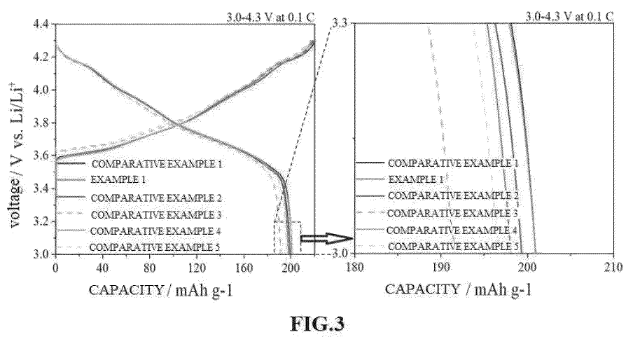

Additionally, FIG. 3 shows a graph of voltage ratio relative to capacitance in secondary batteries manufactured by Example 1 and Comparative Examples 1 to 5 of the present disclosure. Referring to FIG. 3, in the case of Example 1 of the present disclosure and Comparative Examples 2 and 4 in which Mg and Mn, the elements not involved in electrochemical reactions, were used, respectively, it was confirmed that the capacitance exhibited was slightly lower than that in the case of Comparative Example 1. Additionally, in the case of Comparative Examples 3 and 5 in which Mg and Mn were used in excess, respectively, it was confirmed that the capacitance exhibited was significantly low.

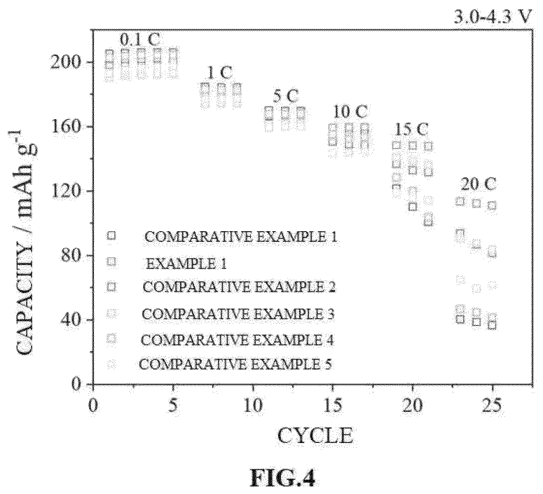

FIG. 4 illustrates a graph of capacitance relative to battery cycles in the secondary batteries manufactured by Example 1 and Comparative Examples 1 to 5 of the present disclosure. Referring to FIG. 4, although Example 1 shows slightly reduced initial capacity due to the impurities of Mg and Mn, not involved in electrochemical reactions, the capacity exhibited is excellent at extremely high rates through an extended lithium layer. Additionally, it is confirmed that both Comparative Example 3, in which about 1 mol % of Mg is used, and Comparative Example 5, in which about 0.5 mol % of Mn is used, exhibit high capacity retention rates at high rates.

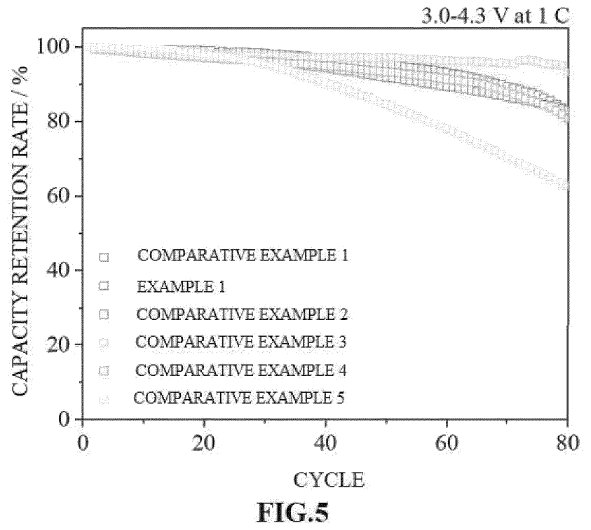

FIG. 5 illustrates a graph of capacity retention rate (%) relative to battery cycles in the secondary batteries manufactured by Example 1 and Comparative Examples 1 to 5 of the present disclosure. Referring to FIG. 5, the capacity retention rates (%) in the case of Example 1, Comparative Example 1, Comparative Example 2, Comparative Example 3, Comparative Example 4, and Comparative Example 5 at 80 cycles are 82.67%, 80.72%, 82.95%, 93.13%, 80.73%, and 62.68%, respectively.

Referring to FIG. 5, it was confirmed that all Example 1 of the present disclosure, prepared using the spent battery leachate in which traces of Mg and Mn were used, Comparative Example 2, in which traces of Mg were used, and Comparative Example 4, in which traces of Mn were used, showed similar capacity retention rates after 80 cycles.

Additionally, Comparative Example 3, prepared using the leachate to which Mg was added in excess, showed a higher capacity retention rate than Comparative Example 2, in which traces of Mg were used. Furthermore, it was confirmed that Comparative Example 5, prepared using the leachate to which Mn was added in excess, showed a higher capacity retention rate than Comparative Example 4, in which traces of Mn were used.

In other words, from FIGS. 3 to 5, it was confirmed that Example 1 of the present disclosure achieved the capacitance and the capacity retention rate that were not inferior to or higher than those in the case of Comparative Example 1, in which the existing transition metal solution was used without involving the spent battery leachate, and Comparative Examples 2 and 4, prepared using the transition metal solutions similar with the transition metal solution of the present disclosure in composition.

Hence, the present disclosure may reduce manufacturing costs and solve environmental problems by replacing some raw materials with the spent battery leachate when preparing the positive electrode active material for secondary batteries.

Additionally, the present disclosure may simplify the preparation process by removing impurities from the spent battery leachate through precipitation and significantly reduce the costs required for spent battery recycling, thereby significantly improving the economic feasibility of spent battery recycling.

Although the present disclosure has been described in detail using preferred embodiments, the scope of the present disclosure is not limited to the specific embodiments and should be interpreted by the appended claims. Additionally, those skilled in the art will understand that various alternatives, modifications, and equivalents are possible without departing from the scope of the present disclosure.

1. A positive electrode active material using a spent battery leachate for a secondary battery, the positive electrode active material having a composition of Li(NiₐCo_{b}Al_{c})O₂ (where a+b+c=1) comprising Ni, Co, and Al and being prepared from a precursor having a composition of NiₐCo_{b} (where a+b=1).

2. The positive electrode active material of claim 1, wherein the precursor has a composition comprising (Na, Al, Fe, Cu, Zn, Mg, Ca, Mn)ₓ (where 0.0001≤x<0.05, and a+b+x=1) in addition to the NiₐCo_{b} composition (where a+b=1).

3. The positive electrode active material of claim 2, wherein the positive electrode active material has a composition comprising (Na, Al, Fe, Cu, Zn, Mg, Ca, Mn)ₓ (where 0.0001≤x<0.05, and a+b+c+x=1) in addition to the ternary Li(NiₐCo_{b}Al_{c})O₂ composition (where a+b+c=1).

4. The positive electrode active material of claim 1, wherein the positive electrode active material has an average particle diameter in a range of 4 to 15 μm.

5. A method of preparing a positive electrode active material using a spent battery leachate for a secondary battery, the method comprising:
preparing a spent battery leachate;
preparing a transition metal solution containing a predetermined amount or more of Ni by increasing a volume of the resulting leachate; and
reacting a mixture of the transition metal solution, an ammonia chelating agent, and a basic aqueous solution in a reactor to prepare a precursor of a positive electrode active material.

6. The method of claim 5, wherein in the reacting of the mixture, the precursor having a composition of NiₐCo_{b} (where a+b=1) is prepared.

7. The method of claim 6, wherein the precursor has a composition comprising (Na, Al, Fe, Cu, Zn, Mg, Ca, Mn)ₓ (where 0.0001≤x<0.05, and a+b+x=1) in addition to the NiₐCo_{b} composition (where a+b=1).

8. The method of claim 5, wherein the preparing of the leachate comprises:
a leachate preparation process to prepare a leachate by subjecting valuable metal powders obtained from a spent battery to acid treatment in a reducing atmosphere; and
an impurity removal process to remove impurities from the leachate.

9. The method of claim 8, wherein the impurity removal process comprises:
a precipitation process to remove impurities comprising Al, Fe, and Cu present in the leachate by adding a basic solution; and
a solvent extraction process to remove impurities comprising Mn, Ca, Zn, and Mg from the resulting leachate, from which some of the impurities are removed through the precipitation process, by using an acid organic solvent.

10. The method of claim 9, wherein in the solvent extraction process, a mixed solvent of di(2-ethylhexyl)phosphoric acid and kerosene is used.

11. The method of claim 9, wherein the impurity removal process further comprises a leachate recovery process to recover NiSO₄, CoSO₄, and MnSO₄ from the resulting extraction solution obtained through the solvent extraction process by using the acid organic solvent, the extraction solution comprising Ni, Co, and Mn extracts containing Ni, Co, and Mn, respectively.

12. The method of claim 5, wherein in the preparing of the transition metal solution, the transition metal solution is prepared by mixing 28 to 35 wt % of the leachate and 65 to 72 wt % of a metal solution for a volume increase to increase proportions of Ni and Co in 100 wt % of the transition metal solution.

13. The method of claim 5, wherein in the reacting of the mixture, the precursor capable of preparing the positive electrode active material is prepared by mixing the transition metal solution, the ammonia chelating agent, and the basic aqueous solution as a reaction solution in the reactor and then reacting the resulting reaction solution for 10 to 30 hours in a nitrogen atmosphere.

14. The method of claim 13, wherein in the reacting of the mixture, a molar ratio of ammonia to a metal salt is in a range of 0.5 to 1.0,
the reaction solution has a pH in a range of 10.0 to 12.0 and a temperature in a range of 40° C. to 60° C., and
the reaction solution is stirred with a stirrer at a speed in a range of 700 to 1500 rpm.

15. The method of claim 5, further comprising sintering a mixture of the resulting precursor being washed to remove impurities, a lithium salt, and an aluminum salt through heat treatment to prepare the positive electrode active material.

16. The method of claim 15, wherein the sintering of the mixture comprises:
a primary sintering process to keep the resulting mixture obtained by mixing the precursor, the lithium salt, and the aluminum salt at a temperature in a range of 300° C. to 500° C. for 3 to 10 hours; and
a secondary sintering process to sinter the resulting product obtained through the primary sintering process at a temperature in a range of 700° C. to 850° C. for 13 to 20 hours.
